(19) United States
(12) Patent Application Publication
(10) Pub. No.: US 2003/0023453 A1
(43) Pub. Date: Jan. 30, 2003

(54) System and method for managing a plurality of rental facilities

(75) Inventors: James Hafen, Lehi, UT (US); William Hoban, Park City, UT (US); James T. Cochrane, Salt Lake City, UT (US); Karl Wenger, Midvale, UT (US); Stephen P. Smith, Sandy, UT (US)

Correspondence Address: MADSON & METCALF, GATEWAY TOWER WEST, SUITE 900, 15 WEST SOUTH TEMPLE, SALT LAKE CITY, UT, 84101

(73) Assignee: Centershift, Holladay, UT

(21) Appl. No.: 10/151,384

(22) Filed: May 20, 2002

Related U.S. Application Data
(60) Provisional application No. 60/308,778, filed on Jul. 30, 2001.

(51) Int. Cl. G06F 17/60

(52) U.S. Cl. 705/1

(57) ABSTRACT

Rental information is stored in a central database. A request to conduct a rental facility transaction is received from a user of web browser over a network. The requested rental transaction is conducted at a central processing center using the rental information. A result for the rental facility transaction is communicated back to the web browser of the user. The rental facility transaction may include operational transactions and management transactions. Changes made by one rental facility transaction are available to subsequent rental facility transactions in real-time.

### RELATED APPLICATIONS

This application claims priority to U.S. Provisional Patent Application Serial No. 60/308,778, filed Jul. 30, 2001, for “System and Method for Managing a Plurality of Resource Leasing Sites,” with inventors James Hafen, William Hoban, James T. Cochrane, Karl Wenger, Stephen P. Smith, which is hereby incorporated by reference.

### BACKGROUND OF THE INVENTION

1. Field of the Invention

The present invention relates generally to the field of rental facility management. More specifically, the present invention relates to a system and method for managing a plurality of rental facilities.

2. Description of Related Background Art

Self-storage facilities provide a secure space, a storage unit, for storing a variety of personal items, everything from boats and RVs to boxes and furniture. A self-storage facility of one type or another can be found in almost every city and town.

Generally, a customer enters a month to month lease to use the storage unit. The customer may then enter and leave the facility at will to use the storage unit. Access may be controlled by security gates, doors, and locks. If a customer does not pay the monthly rent, the customer may be locked out of the storage unit until the bill is paid. A notice may be sent to the customer. Extra fees may be charged, and eventually, based on local laws, an auction of the contents of the storage unit may be held to recover lost rents. In addition to leasing storage units, a facility may sell merchandise such as tarps, plastic sheeting, packing tape, boxes, twine, and the like. A customer may also purchase insurance for the contents of the storage unit through the facility.

Generally, the market for self-storage services is volatile. Therefore, facilities hold promotions to attract new customers. For example, the promotion may be for fifty-percent off the rent for the first month for new customers. In addition, rental rates may change monthly based on the market. Factors well known to those in the industry may influence a rate change and which customers are affected.

Thus, management of a facility may become very complicated as business rules are implemented to make the most of quickly changing business opportunities. Ownership and/or management of self-storage facilities may be structured in a variety of ways. For example, an individual or company may own multiple facilities and employ a manager to handle day-to-day operations at each facility. Alternatively, a managing company may provide management services to the owners of the facilities. In yet another alternative, the facilities may be independently owned and operated, but subject to a franchise agreement.

An owner or manager of multiple facilities (herein referred to as a “managing company”) wants to build and preserve good will and profits through consistent policies and procedures (known herein as “business rules”) in conducting business at the different facilities. Conventionally, policies are implemented with printed manuals, inspections, manual oversight and management. However, each facility manager may interpret the same policies differently resulting in tarnished goodwill and lack of consistency between the facilities. Personnel training and oversight of facilities may be difficult due to geographic separation between facilities.

Conventionally, each facility records information for operational and management transactions performed each day. Described in more detail below, operational transactions are those which relate to day-to-day operation of the rental facility and management transactions are those which relate to management functions associated with the rental facility. Some facilities record the information manually, using accounting books, and paper records of receipts and invoices. Typically, one of many different facility management software programs are used on a personal computer. These programs streamline operation and management of a facility.

A managing company may require that each facility use the same individual facility management software. This helps each facility to be efficient but provides limited help in collectively managing the multiple facilities. However, a managing company may want facilities to follow certain business rules to maximize profits. These policies may include when and how rate increases are to be implemented, hours of operation, a refund policy, a delinquent account processing procedure, a standard lease template, and the like. However, managing multiple facilities based on policies has significant limitations.

Policies may be intentionally neglected or misunderstood. For example, a facility manager may rent storage units to friends at no cost or a reduced rate. Or, the facility manager may handle delinquent accounts improperly in violation of local laws. Training for and enforcing the business rules may require routine visits involving costly travel.

To facilitate management decisions for multiple facilities, the managing company may collect facility-specific information for operational transactions at each facility. Conventionally, each facility manager prints a report from the local software program which is faxed to the managing company. The faxed information may then be entered manually into a second software program, such as a spread sheet to allow for side-by-side comparisons of facilities and grand totals. Of course, manual entry is time consuming and generally increases the risk for human errors.

Alternatively, the information may be collected electronically by polling each facility or having each facility dial-in to a main server computer. However, such information is typically collected only once a day. This 24 hour delay may be too restrictive for making management decisions.

Furthermore, effective operation of the managing company may be hindered by lost or corrupted facility-specific information. A failure of a facility computer may destroy the important facility-specific information. Recovery from the loss may require a visit to the facility resulting in significant down-time.

Facility-specific information may be recovered from a back up. However, facility managers often neglect to perform regular backups. In addition, due to limited storage space on facility computers, conventional facility management software does not keep information on accounts which are closed when a customer vacates a storage unit. Thus, a repeat customer must provide basic account information (name, address, etc.) again. Such repetition may annoy customers.

Alternatively, a customer may move to a new city and want to use a self-storage facility operated by the same managing company. However, facility-specific information, such as rental accounts, is not generally shared between facilities. Therefore, a current customer may have to provide personal information a second time in the new city.

Accordingly, what is needed is a system and method for managing a plurality of rental facilities that allows business rules to be enforced at each facility and modified in real-time with minimal effort. What is also needed is a system and method that allows operational and management transactions to be performed for a single facility and for a plurality of facilities as defined by business rules associated with the transactions. In addition, what is needed is system and method that stores rental information for each facility in a central location which is remotely accessible. Also, what is needed is system and method that allows monitoring of whether business rules are being followed by facilities. Further, what is needed is a system and method that allows software modules to be modified once and available to each facility in real-time.

### BRIEF DESCRIPTION OF THE DRAWINGS

Non-limiting and non-exhaustive embodiments of the invention are described with reference to the figures, in which:

FIG. 1 is a block diagram of a communication system linking rental facilities to a central processing center;

FIG. 2 is an illustration of simple hardware components which may be used at a facility with certain embodiments of the present invention;

FIG. 3 is a block diagram of logical components within one embodiment of a central processing center;

FIG. 4 is a dataflow diagram illustrating data flow for rental facility transactions which may be executed by a facility manager;

FIG. 5 is a block diagram illustrating a rental facility transaction including operational transactions and management transactions;

FIG. 6 is a dataflow diagram illustrating data flow for management transactions;

FIG. 7 is a dataflow diagram illustrating examples of management transactions and operational transactions;

FIG. 8 is a dataflow diagram illustrating data flow for operational transactions available in one embodiment to users other than facility managers;

FIG. 9 is a block diagram of logical components of a system for managing a plurality of rental facilities; and

FIG. 10 is a flowchart of a method for managing a plurality of rental facilities.

### DETAILED DESCRIPTION OF THE PREFERRED EMBODIMENTS

The present invention relates to a system and method for managing a plurality of rental facilities that eliminates or substantially diminishes all of the above-identified problems and disadvantages.

In one embodiment, a request to execute a rental facility transaction is received. The request may be sent by any communication device supporting web browsing capabilities, such as a computer terminal, personal digital assistant (PDA), personal computer, or the like. The request may be received, for example, by a central processing center including a web server farm linked to the communication device via a network communication link. The request may be embodied in any suitable format according to standard networking protocols.

Preferably, the central processing center is in communication with a central database which stores rental information. The central database stores rental information in any suitable format. The rental information may include current active rental account information as well as historical information regarding closed rental accounts and past rental facility transactions. By retaining historical information, reports and other queries on the historical information may be run to help forecast demand for rental services and provide other data mining capabilities. The rental information includes business rules associated with rental facility transactions, system information, facility-specific information, and the like. Certain rental facility transactions allow the rental information to be changed in the central database in real-time.

A requested rental facility transaction may be identified from the request. The requested rental facility transaction is executed according to the business rules associated with the particular rental facility transaction. The requested rental facility transaction may be a management transaction or an operational transaction. For each requested facility transaction there may be common and facility-specific business rules which apply. These business rules are applied as the rental facility transaction is executed. Once the requested rental facility transaction is completed, a result is communicated back to the web browser which sent the request.

The requests may be received by a web software component. One management transaction may include, for example, modifying the code for the web software component in real-time. Another management transaction may include generating a report containing at least a portion of facility-specific information for at least one rental facility. In certain embodiments, the rental facility includes a self-storage rental facility.

Various operational transactions, which are well known to those of skill in the art, may be requested. Some examples of operational transactions include, modifying facility-specific information to reserve a rental unit for a user, processing a rent payment for a storage unit, processing a sale of merchandise, managing an existing or delinquent rental account, and the like.

The recipient may be authorized using information contained within the request. The request may contain, for instance, an authorization indicator which represents the level of access to rental facility transactions allowed for a user. The authorization indicator may be compared with an authorization level required for the requested rental facility transaction. If the authorization indicator does not satisfy the required authorization level, the user's request is denied. Otherwise, the request is allowed and the requested rental facility transaction is completed.

As mentioned, a request may originate from a web browser via a network communication link. The network communication link may comprise the Internet. Thus, a user may request and execute a rental facility transaction while being physically remote from the rental facility which is the subject of the rental facility transaction. In certain embodiments, the web browser caches persistent rental information, information which changes infrequently.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

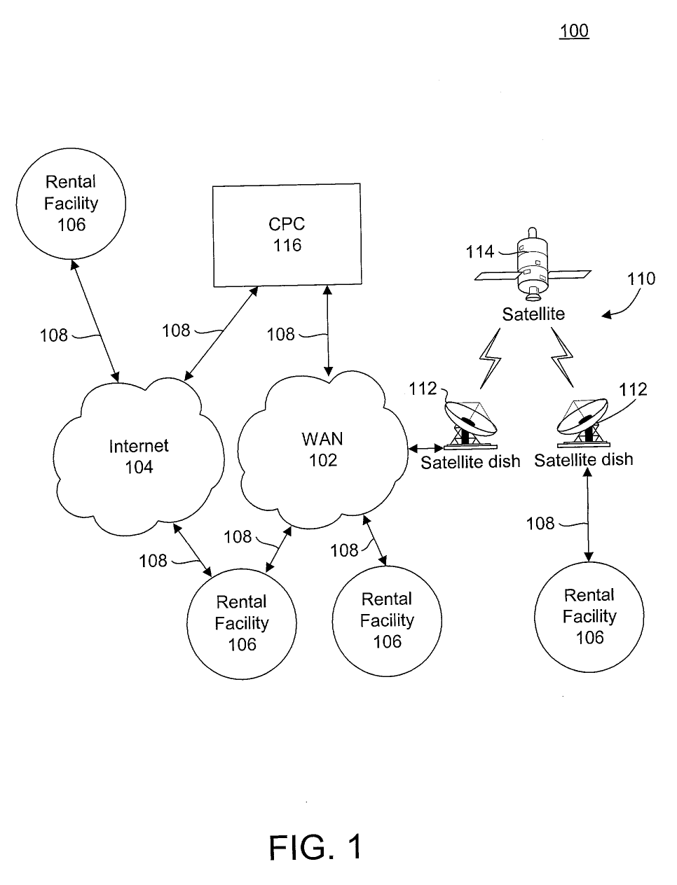

Referring now to FIG. 1, there is shown a communication system 100 according to an embodiment of the invention. In one implementation, the system 100 includes a wide area network (WAN) 102, such as a private corporate network, although other networks are possible. Alternatively, or in addition, the system 100 may include the Internet 104. The Internet 104 is a “network of networks” and is well known to those skilled in the art. Communication over the Internet 104 and WAN 102 may be accomplished using standard protocols, such as TCP/IP (Transmission Control Protocol/Internet Protocol) and the like.

The system 100 may include a plurality of rental facilities 106 located, for instance, in a plurality of cities or towns. Generally, a rental facility 106 is a self-storage rental facility that allows a customer to lease a storage unit. The following specification describes self-storage rental facilities. However, those of skill in the art recognize that the invention may be used with other rental facilities including time shares, parking garages, and the like.

The rental facilities 106 are coupled to the WAN 102 and/or Internet 104 by way of a network communication link 108. Information may be transmitted along network communication link 108 using standard protocols including HTTP (Hyper-Text Transfer Protocol), HTTPS (Secure Hyper-Text Transfer Protocol), FTP (File Transfer Protocol), and the like.

As mentioned above, rental facilities 106 may be in a variety of geographic locations. Depending on the communication infrastructure available to a rental facility 106, the network communication link 108 may be embodied in different forms. For example, in a large city, a facility 106 may have easy access to the WAN 102 and/or the Internet 104. In another city, a facility 106 may only have access to the Internet 104 via a dial-up connection. In a remote town, the facility 106 may not have access to the Internet 104 or the WAN 102. Instead, a satellite link 110 may be provided for the facility 106. The satellite link 110 may include a first satellite dish 112 coupled to the WAN 102 (or alternatively the Internet 104) and a second satellite dish 112 coupled to the facility 106. Of course a satellite dish 112 may be coupled directly to the CPC 116. Two-way communications are relayed through one or more satellites 114 from one satellite dish 112 to the other. Thus, the system 100 allows a facility 106 to use existing communication infrastructures. Additional phone lines, high-speed internet connections, or special dedicated connections are typically not required.

Preferably, the system 100 includes a central processing center (CPC) 116. The CPC 116 communicates with the facilities 106 to conduct rental facility transactions. The CPC 116 may be coupled to the Internet 104 and the WAN 102 via network communication links 108. Of course, the communication system 100 illustrated in FIG. 1 is merely exemplary, and other types of devices and networks may be used within the scope of the invention.

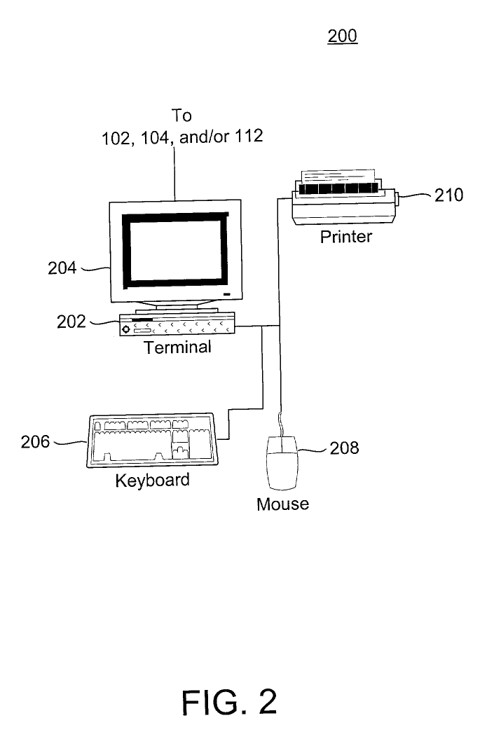

Referring now to FIG. 2, there is shown a rental facility system 200 according to an embodiment of the invention. As depicted, the system 200 may include a terminal 202, a monitor 204 (or other display device), a keyboard 206, a mouse 208, and a printer 210.

The terminal 202 may be a very simple electrical component configured to provide only the necessary computing functionality to execute web browser functionality. Conventionally, the terminal 202 may be referred to as an Internet appliance, or ‘dumb’ terminal because the sole purpose for the terminal 202 is to view web pages and conduct transactions over the Internet 104 or WAN 102. The terminal 202 may not include functionality for autonomous operation (use when disconnected from the Internet 104 or WAN 102). Alternatively, the terminal 202 may be a personal computer capable of autonomous operations.

Due to the simplicity and limited functionality of the terminal 202, these devices are generally inexpensive. Generally, the terminal 202 includes a central processing unit (CPU), an audio/video controller, an input/output controller, and a limited amount of random access memory (RAM). In addition, certain terminals 202 may include a small storage device (disk drive). These components are well known. Similar conventional components perform at levels far above that required to execute conventional web browser software. Therefore, prices for hardware components which function satisfactorily for web browser functionality are inexpensive and plentiful. Thus, if the terminal 202 malfunctions, or breaks down, a replacement may be provided for minimal expense.

The monitor 204, keyboard 206 and mouse 208 provide well known functions allowing a user to operate and interact with the web browser being executed on the terminal 202. The printer 210 allows a user to print hard copy reports, pages, and images displayed in the web browser.

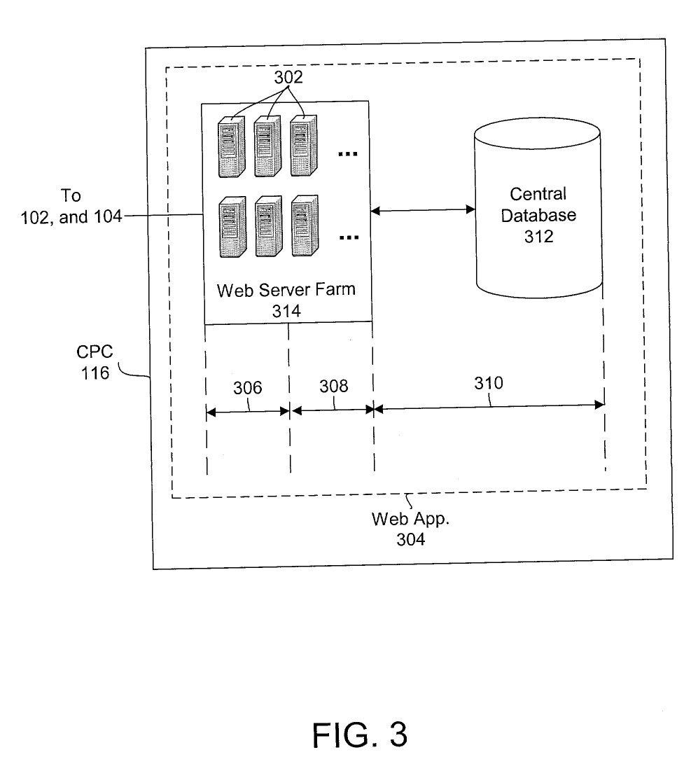

Referring now to FIG. 3, a block diagram illustrates logical components of a central processing center (CPC) 116 according to one embodiment of the invention. The CPC 116 serves as the main processing center for rental facility transactions. As will be discussed in more detail below, a request for a rental facility transaction is received by a web server 302 located in the CPC 116. The web server 302 may be coupled to the WAN 102 and the Internet 104.

Generally, a web server 302 is a computer which is dedicated to serving up web pages to web browsers and hosting web applications 304. A web server 302 generally includes multiple processors and large storage devices for this purpose. A web application 304 is one or more software programs that allow a user to interface with a software program over the World Wide Web (WWW) or other network using standardized protocols and a standardized software interface, a web browser, executing on the user's terminal or computer.

Generally, web applications 304 have an architecture which includes a plurality of tiers. Each tier provides distinct functionality for the web application 304. In the illustrated embodiment, a logic and presentation tier 306, business tier 308, and data tier 310 cooperate to define the web application 304. Each tier 306, 308, 310 may be implemented using a variety of different software components. For example, Microsoft's internet information services (IIS) software, web forms, visual basic scripts, java scripts, or the like may be used alone or collectively in different tiers 306, 308, 310. Alternatively, a web application 304 may be an existing software application which is modified from a one or two tier architecture to three or more tiers architecture. Such software applications may be referred to as web-enabled applications.

Generally, the logic and presentation tier 306 provides the functionality which defines the logical flow of interaction between a user and the web application 304. For example, scripts requiring a user to enter a user name and password before other functions are permitted may be part of the logic and presentation tier 306.

The business tier 308 includes business rules and business objects which provide functionality specific to a particular business such as rental facility management. For example, the business tier 308 may include a formula to calculate the desired markup on merchandise for a particular business.

The data tier 310 includes software components for accessing and modifying data which is associated with the web application 304. Exemplarary components may include open database connectivity (ODBC) components, proprietary database dynamic link libraries (dlls), as well as the database engines and data files which are used to store and manage the data. In FIG. 3, the data tier 310 includes a central database 312.

In certain embodiments, the data tier 310 includes rental information stored within the central database 312. Rental information, as used herein, refers to substantially all the data associated with managing and operating at least one rental facility 106. Rental information may be divided into business rules, system information, and facility-specific information. Business rules define the policies and rules regarding transactions and other operations to be performed at or on behalf of a facility 106. Business rules may be defined as stored procedures within a database, functions defined in an active server page, or the like. Thus, rental information is not limited to the information stored within a database.

System information relates to information associated with the whole rental facility management system. System information may include a listing of all the facilities currently connected to the web application 304 at any given time. System information may also include information tracking the transactions which have been completed by the system.

Facility-specific information is information which is unique to a specific facility. For example, facility-specific information may include a facility's address, or the rental accounts created by a specific facility. Described more below, a rental account is an account associating a customer with a specific storage unit. Facility-specific information may also include information associated with operational transactions performed on rental accounts associated with a particular rental facility 106.

The logic and presentation tier 306 and business tier 308 generally utilize the web server's CPU and RAM. The data tier 310 primarily also use a storage device such as a disk drive. While the tiers 306, 308, 310 are illustrated as clean separate components, those of skill in the art recognize that the elements of one tier may be implemented by hardware and/or software which primarily manages elements of another tier. For example, business rules may be implemented as procedural language/structured query language (PL/SQL) stored procedures which are executed by a database engine rather than a business object or business function.

Conventionally, software applications for managing a rental facility 106 are stand-alone applications which run on a single personal computer (PC). Alternatively, the application may use a client-server architecture. However, these architectures have only one or two tiers which causes significant problems for managing a plurality of rental facilities 106.

One problem is in maintaining and/or changing the software application. Conventionally, each rental facility 106 must have a personal computer to operate the client or stand-alone rental facility management software product. If the software has bugs, or a main managing company desires to change business rules at one or more facilities, the software may need to be replaced by new software which includes the fix and/or business rule change. Coordinating the updating of the software may cause significant interruptions of a rental facility business.

By contrast, as illustrated in FIG. 3, with multiple tiers 306, 308, 310, rather than replacing the entire web application 304 a single tier may be replaced to fix a software bug or change functionality. In addition, multiple tiers facilitate debugging the web application 304 to avoid most software bugs. Software code defining the web application 304 may be modified at the CPC 116 and change is available to each rental facility 106 almost instantaneously.

Another problem is that facility-specific information generated by operational transactions is not centralized. This information is typically stored on the local hard drive at the facility 106. However, to make management decisions regarding the rental facilities collectively, this information needs to be collected and organized for company managers. Conventional solutions, discussed above, such as faxing a report to a central office for manual entry, or retrieving the information from each facility 106 once a day, are error prone, time consuming, and inefficient.

However, with a central database 312, substantially all the rental information, including facility-specific information generated by operational transactions, is stored in a single location. Thus, a company manager may query the central database 312 to generate a report at any time and receive the most current information about one or more rental facilities 106.

With a central database 312, historical rental information may be preserved because the storage capacity of the central database 312 may be readily increased. Thus, a company manger may generate a report based on historical information from closed rental accounts. Alternatively, a closed rental account may be easily reopened if a past customer returns for additional rental services, or rents from an affiliated facility 106.

Having a single central database 312 allows rental information to be easily backed up and/or duplicated to provide redundancy and prevent data loss due to an emergency. Furthermore, if the computer equipment 200 at a facility 106 fails, no data is lost. Replacement equipment 200 may installed and the facility 106 is quickly returned to normal operation.

The CPC 116 may include a web server farm 314. Depending on the amount of requests that are expected for the web application 304, a plurality of web servers 302 may be organized to form the web server farm 314. If one web server 302 is occupied with a current request, subsequent requests are taken by another web server 302 in the farm 314. In this manner, each request is serviced in as short a time as possible. Accordingly, each web server 302 in the web server farm 314 may simultaneously execute portions of the web application 304.

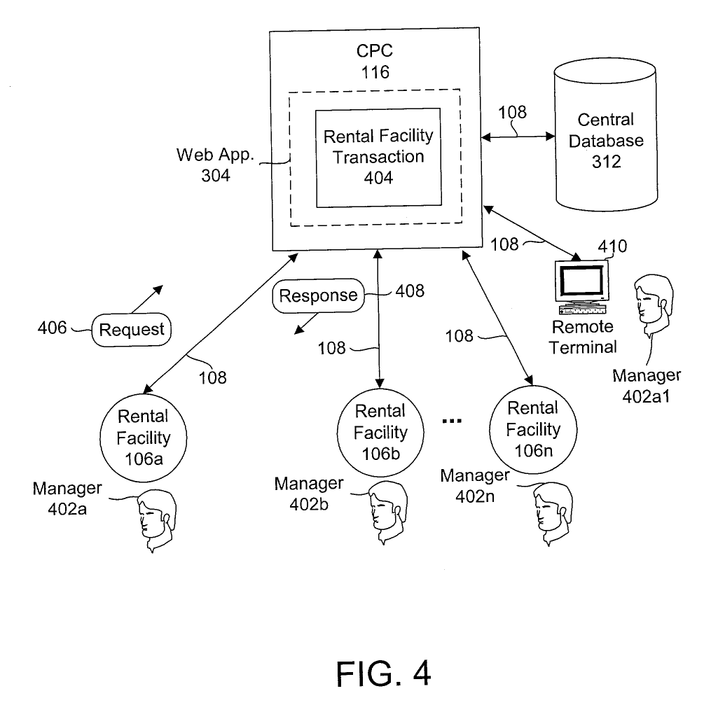

Referring now to FIG. 4, logical components illustrate data flow in one embodiment of the present invention. The central database 312 may be physically remote from the CPC 116. For example, the central database 312 may be a data center coupled to the CPC 116 via a network communication link 108. The central database 312 stores rental information for a plurality of facilities 106a-106n.

Generally, each rental facility 106 is operated by a manager 402. The manager 402 is responsible for the day-to-day operations and management of a facility 106. The manager 402 may also provide security for the facility property during non-business hours.

In one embodiment, the manager 402a operates a web browser on a computer system 200 at the facility 106a. The manager 402a may connect to the web application 304 using the communication link 108 by entering a specific uniform resource locator (URL). The manager 402a may then be required to login using a user name and password. Then, a new web browser window may be opened. The new web browser window may hide substantially all the menus and user interface buttons of the web browser software program. Thus, a user is limited to using interface buttons provided in the web application 304.

A web browser is software which communicates with a web application using standard networking and web browsing protocols. A variety of web browsers exist including Microsoft Internet Explorer® and Netscape®. The web browser may automatically down load a number of plug-ins to allow certain functionality with the web application 304. Alternatively, the plug-ins may be downloaded in a relatively short installation step.

In another embodiment, for efficiency, the web browser may cache rental information which changes infrequently. This information is referred to as persistent rental information. The persistent rental information remains substantially the same for at least a day or more. For example, the sales tax percentage for a particular facility may only change once a year. However, for each sale of merchandise the sales tax percentage may be required. Rather than transmitting the percentage repeatedly from the central database 312 to the web browser, the cached value is used.

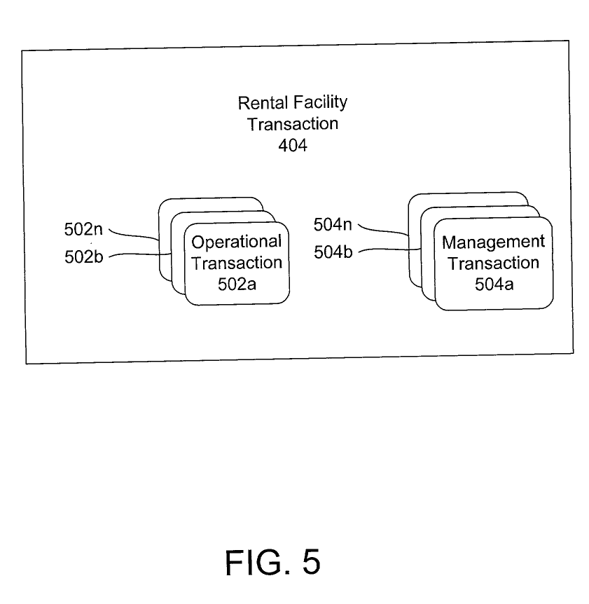

Once logged in to the web application 304, a manager 402a generally performs one or more rental facility transactions 404. Referring now to FIG. 5, a rental facility transaction 404 includes all transactions associated with one or more rental facilities 106a-106n. A rental facility transaction 404 includes operational transactions 502a-502n and management transactions 504a-504n.

An operational transaction 502 is a transaction which is associated with the day-to-day operation of a rental facility 106. For example, processing a sale of merchandise sold at a rental facility 106 is an operational transaction 502.

A management transaction 504 is a transaction associated with the management activities for one or more rental facilities 106. For example, one management transaction 504 may be to provide a new employee with access to use the web application 304. Other examples, of operational transactions 502 and management transactions 504 are well known to those of skill in the art.

Referring now back to FIG. 4, similar to conventional software, the web application 304 may provide a menu or other user interface components for selecting a rental facility transaction 404. Selection of a menu item may cause a request 406 to be sent from the web browser at the facility 106a to the CPC 116 via the communication link 108. The format for the request 406 may be one of a variety of formats well known to those of skill in the art and is not crucial to the invention.

Preferably, the request 406 is transmitted according to standard networking and/or Internet protocols. Certain requests 406 may be encrypted to provide security for the information being transmitted. Alternatively, all requests 406 may be encrypted.

The request 406 is received by the web application 304. Then, the request 406 is interpreted to determine which rental facility transaction 404 is being requested. Next, the web application 304 conducts the requested rental facility transaction 404.

Certain rental facility transactions 404 may be conducted without further input from the manager 402. Some requests 406 may include information from a manager 402 which is needed to complete the requested rental facility transaction 404. For example, a manager 402a may request 406 creation of a new rental account. Therefore, the request 406 may include the personal information (name, address, etc.) of a new customer.

Alternatively, the requested rental facility transaction 404 may include multiple steps which require an interchange with the manager 402a. In this case, information is passed between the web application 304 and the web browser until the manager 402a has completed all the necessary steps to execute the rental facility transaction 404.

Once the rental facility transaction 404 is completed, a response 408 is communicated to the manager 402a using the web browser. The response 408 represents the result of the rental facility transaction 404. The format of the response 408 is directly related to the nature of the rental facility transaction 404. For example, if execution of the rental facility transaction 404 requires manipulation of the rental information stored in the central database 312, once the transaction is finished a simple acknowledgement indicating success may be sent to the manager 402a. Alternatively, the response 408 may include a web page representing a requested report. Of course, the response 408 may be of a variety of formats.

Referring still to FIG. 4, because the web application 304 uses a standard web browser to interface with a user and the rental information is stored in the central database 312, there is no requirement that the manager 402 use computer equipment 200 at the facility 106 for rental facility transactions 404. Thus, a manager 402a1 may be on vacation or a road trip almost anywhere in the world and execute a transaction 404 for his or her facility 106a. The manager 402a1 may use a remote terminal 410 with a network communication link 108 to the CPC 116. The remote terminal 410 may be a public terminal 410 in an Internet cafe, a personal laptop computer, or other device capable of executing a standard web browser and establishing the network link 108.

Because all rental information is stored within the central database 312, each manager 402a-402n could have access to rental information for a single rental facility 402a, all rental facilities 402a-402n, or some subset thereof. For certain rental facility transactions 404, access to all rental information may be required. For example, a report may be available which compares the manager's facility 106a to all the other facilities 106b-106n. For other rental facility transactions 404, a manager 402 may only have access to his or her facility-specific information.

In addition, when a transaction modifies rental information, the change is available to the same manager 402a, or all managers 402a-402n in real-time. Thus, a report of daily sales of merchandise for all facilities 106 may be reproduced at various times throughout a business day to see how sales for one facility 106 compares other facilities 106.

The rental facility transactions 404 available to a manager 402 may be restricted using security access levels associated with each manager 402. For example, an authorization indicator (not shown) may be read from the request 406. The authorization indicator may be compared to an authorization level (not shown) associated with the requested transaction 404. If the authorization indicator does not satisfy the appropriate authorization level, the user's request is denied. Otherwise, the requested transaction 404 is executed as expected.

Referring still to FIG. 4, as discussed above, the web application 304 may include a business tier 308 in which business rules (not shown) for managing and operating rental facilities 106 are defined. Each rental facility transaction 404 may be associated with one or more business rules. Certain business rules may be associated with operational transactions 502 and others with management transactions 504. Preferably, the business rules are incorporated into the rental facility transactions 404.

Business rules may include common business rules and facility-specific business rules. Common business rules are rules which are to apply to all or a majority of rental facility transactions 404. For example, all requests 406 to process a credit card number may require that a manager 402 enter a personal identification number (PIN) a second time to verify the manager's identity.

Facility-specific business rules are rules which modify or replace common business rules due to circumstances specific to one or more facilities 106. Different local laws may be implemented using facility-specific business rules. For example, Florida facilities 106 may be prohibited from charging sales tax on the sale of merchandise. However, the common business rule may be that sales tax is always charged. Thus, the facility-specific business rule may modify the common business rule to exclude sales tax for sales at Florida facilities 106.

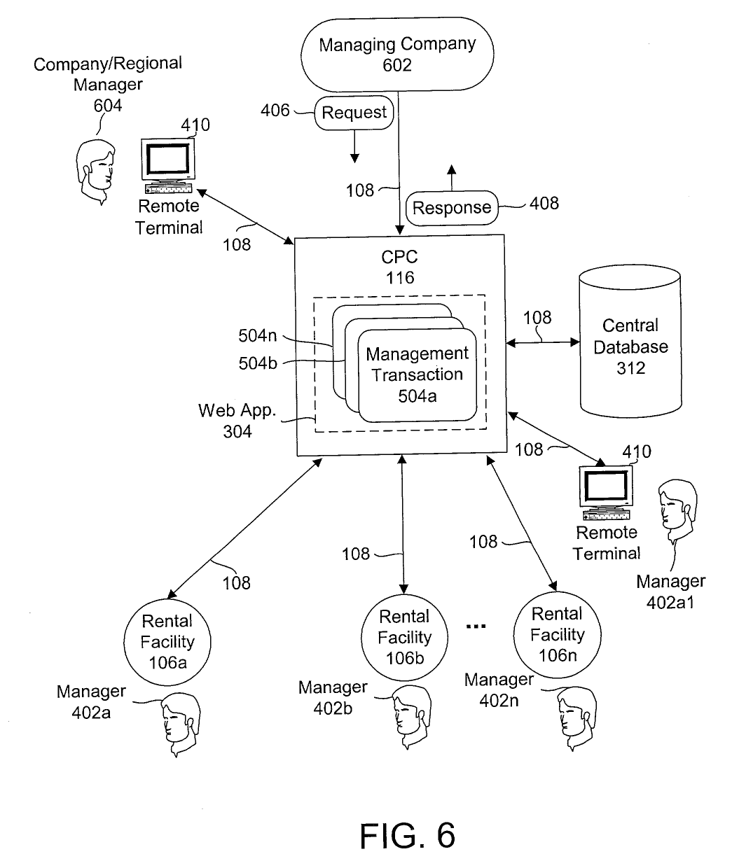

Referring now to FIG. 6, a managing company 602 may execute rental facility transactions 404 (shown in FIG. 4). More specifically, company managers 604 at a regional or company wide level may perform management transactions 504. Of course facility managers 402a-402n may also execute management transactions 504 specific to their facilities 106.

A managing company 602 is an entity which ensures that one or more facilities 106 are operated and managed in a consistent, efficient, and high quality manner. Such management may be achieved by associating business rules with the rental facility transactions 404 and the central database 312. Thus, Facility managers 402 are not left to their own discretion in determining how to implement company policies and procedures, business rules.

As with facility managers 402, the company managers 604 may issue a request 406 to execute a management transaction 504 and receive a response 408 once the management transaction 504 is completed. In addition, company managers may request management transactions 504 from a remote terminal 410.

Certain management transactions 504 may include maintenance and modification of the web application 304. The web application 304 may include a plurality of script files (not shown) stored in the CPC 116 and/or in the central database 312. A web software component of the web application 304 receives a request 406 for a management transaction 504 to modify or replace one or more script files. This management transaction 504 modifies the code of the web application 304. The modified code is then available to all subsequent requests 406 in real-time. A management transaction 504 may modify the code to change, add to, or remove business rules and/or associated rental facility transactions 404, or other functionality of the web application 304 in real-time. Of course the code may also be modified to fix software bugs.

Alternatively, a management transaction 504 may modify general rental information or facility-specific information within the central database 312 in real-time. For example, a company/regional manager 604 may remotely execute a management transaction 504 which waives the fees and rolls back the accounts receivable information for a specific rental account. Once the management transaction 504 is completed, a facility manager 402 may immediately execute an operational transaction 502 to process a payment of any remaining balance on the same rental account while the customer waits in the facility office.

Furthermore, a company/regional manager 604 at the managing company 602 may request 406 a management transaction 504 for generating a report comprised of facility-specific information for one or more facilities 106. The facility-specific information includes the most recent changes made in real-time. For example, a company/regional manager 604 may want a report of the number of move-ins for the last two hours. The company/regional manager 604 may receive the report as a web page response 408 which may be printed from the web browser.

Other management transactions 504 available to the managing company 602 may include tracking and reporting system information. This may be done to track use of the web application 304 as well as identify software errors. For example, a company/regional manager 604 may produce a report indicating which facility managers 402 have logged into the web application 304, when they last logged in, and what transactions 404 were completed. So, the company managers 604 may determine whether the facility managers 402 are using the web application 304 properly. Of course, the present invention allows for a variety of other management transactions 504 suitable for particular embodiments of the present invention.

In certain management transactions 504, a user may be permitted to override the applicable common or facility-specific business rule. For example, a facility manager 402 may be permitted to waive certain fees. However, such overrides may be tracked and monitored such that a company/regional manager 604 may receive a notification if the number of overrides performed exceeds a particular threshold.

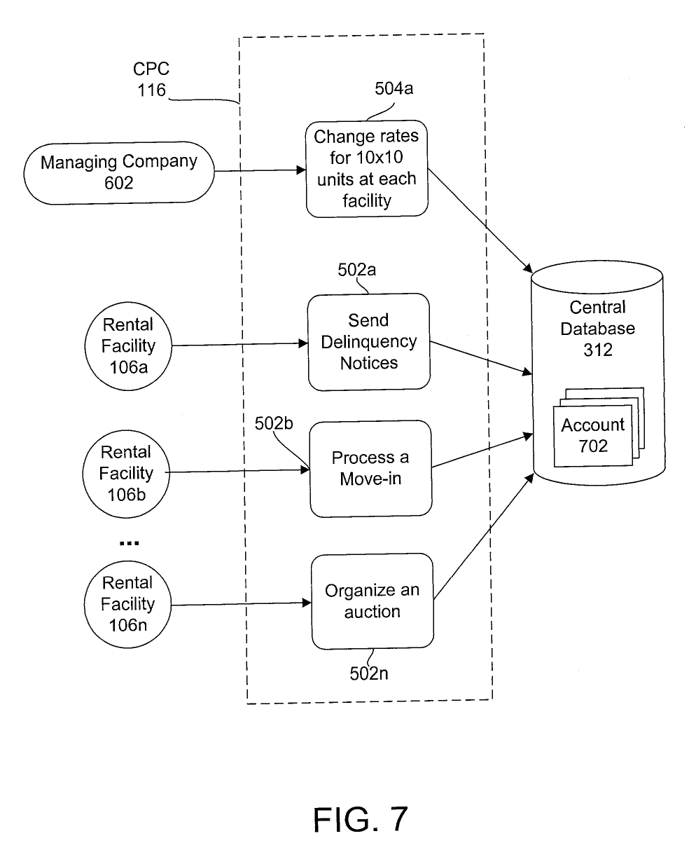

In FIG. 7, examples of management transactions 504 and operational transactions 502 are illustrated. Conventionally, to change the rental rates at each facility, phone calls and/or meetings may be held with each facility manager 402. Still, a managing company 602 was not guaranteed that the facility manager 402 would properly implement the rental rate change. Alternatively, stand-alone software at each facility may be updated. Simply changing the rental rates is generally plagued with delays and uncertainty for the managing company 602.

In contrast, in certain embodiments of the present invention, a company/regional manager 604 may request 406 a rental rate change management transaction 504. For example, the transaction 504 may increase the rates on all 10×10 storage units at each facility 106. Based on local laws, occupied storage units may be scheduled to receive notices of the rate increase which may be automatically increased when the notice period expires. Vacant units will immediately require the higher rate. The changes are recorded in the central database 312 and the managing company 602 is relieved of the conventional overhead and uncertainty typically associated with such a change.

Often, a customer of a self-storage facility 106 has one or more rental accounts 702. The rental account 702 records specific information regarding the accounts receivables, payment history, description of the storage unit being rented, contact information for the customer and other such pertinent information. Management of rental accounts 702 may include a variety of functions.

For example, when a new customer comes into the facility 106b a new account 702 may be established. Generally, the facility manager 402 records information from the customer such as contact information, description of unit to be rented, the rental rate, whether a new customer promotion is to be applied, how the customer decided to use this facility 106b, creating a PIN to allow secure access to the facility 106b, and other such information. Then, the operation transaction 502b is executed to process a new move-in. Processing the new move-in may include other modifications to the rental information in the database 312.

Management of an existing account 702 may include processing a monthly payment from the customer, changing the rent for the storage unit associated with the account 702, modifying contact information or a PIN number, scheduling and conducting inspections of the storage unit, applying late payment fees, adding or canceling insurance for personal items in the storage unit, and the like. Of course a number of other different management activities may exist involving an existing rental account 702.

If a customer fails to make payments, there are a number of management functions which may be performed on the delinquent rental account 702. Generally, local laws and/or a lease agreement between the facility 106 and the customer impose certain requirements for managing delinquent rental accounts 702. In some jurisdictions, if a facility 106 follows appropriate steps, a lien may be placed on the contents of the storage unit to compensate for lost rents.

Processing of a delinquent account 702 may proceed as follows. First, the facility 106 may impose a fee for non-payment. Next, the facility 106 may apply an over lock to the storage unit. The over lock may include a second physical lock applied to the storage unit to lock out the customer who typically has their own key for the first lock. Alternatively, the customer's access code for an electronically locked storage unit may be deactivated. A customer's PIN for access through the facility gate may also be deactivated. As time passes and the account remains delinquent, one or more notices of the delinquency and future actions which the facility 106 may take may be sent to the customer. Finally, if a lien is applied and sufficient time passes without the customer paying the back rents and associated fees, the facility 106 may organize and hold an auction of the personal items in the storage unit. The proceeds of the auction may be used to recoup a portion of the lost rent.

Therefore, management of delinquent rental accounts 702 may involve a number of management actions which may be spread over weeks or months. Tracking and properly carrying out these management tasks may overwhelm a facility manager 402. If properly managed, some compensation for the storage unit may be recovered. If not, the facility 106 may recover nothing and/or may incur legal problems.

Specific operational transactions 502 may facilitate management of delinquent accounts 702. For example, one operational transaction 502a allows sending of a batch of delinquency notices according to a schedule. The notices may be processed by a mass mailing company (not shown). The mass mailing company may provide a low bulk rate, convenience, and quality superior to each facility 106a processing their own delinquency notices.

Certain management functions for delinquent accounts 702 may be handled directly by the web application 304. For example, processing batches of form letter delinquency notices 502a, deactivation of access PINs, and the like.

Alternatively, the web application 304 may facilitate the delinquent account processing. For example, the web application 304 may produce a daily to-do list for facility managers 402. The to-do list may include operational transactions 502 which are time sensitive and must be done by a facility manager 402. For example, an operational transaction 502n for organizing an auction may require that the scheduled auction coincide with the facility manager's schedule.

Other operational transactions 502 include processing a sale of merchandise and payment of rent. For example, the web application 304 may use a network link 108 to communicate with a financial processing center (not shown) such as a bank to authorize payment for the merchandise with a credit or debit card. Records of the amount of merchandise in stock may be adjusted to reflect recent merchandise sales. Similarly, another operational transaction 502 may process the payment of rent for a storage unit by communicating with a financial processing center (not shown).

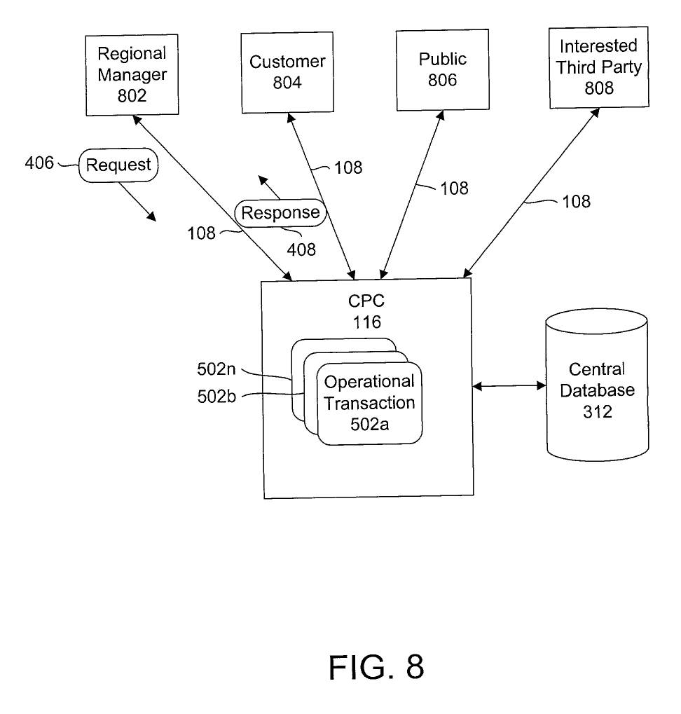

FIG. 8 illustrates an embodiment in which operational transactions 502 are available to regional managers 802, customers 804, the general public 806, and interested third parties 808. Network links 108 over the Internet 104 allow users to perform operational transactions 502 in real-time which are difficult or impossible with conventional facility management software.

For example, a regional manager 802 may generate reports comparing any number of facilities 106 using a variety of rental information. The regional manager 802 may similarly change the rental information for a number of rental facilities 106 in real-time. Of course other operational transactions 502 as well as management transactions 504 may be performed by the regional manager 802.

Customers 804 may perform operational transactions 502 to check the status of their rental accounts 702. A customer 804 may make on-line rent payments or change contact information.

The general public 806 may be allowed to review features and vacant storage units at a particular facility 106. Some rental facilities 106 may be in high demand, especially for storage units of a particular size. Often, customers 804 and/or the public 806 may get on a waiting list or reserve a storage unit for a limited period of time. Conventionally, reservation and waiting list services may be offered by using a conventional website but the reservations are not available in real-time. These delays may prevent a managing company 602 from guaranteeing the reservation.

By contrast, operational transactions 502 may be executed by customers 804 and/or the public 806 to provide reservations and inclusion on a waiting list in real-time. The facility-specific information in the database 312 is modified in real-time. Thus, a managing company 602 can guarantee the reservation.

As mentioned above, ownership and management of rental facilities 106 may be arranged in a variety of ways. Therefore, the manager of a facility 106 and the owner may be different people or entities. The owners or investors in one or more facilities 106 comprise interested third parties 808.

For example, a holding company may own three facilities 106 which are managed and operated by another managing company 602. The profits from the three facilities 106 may be divided between the holding company and the managing company 602. Thus, as an interested third party 808, the holding company, may execute certain operational transactions 502 to review financial projections. For example, a holding company may generate a report projecting rents to be received in the next six months.

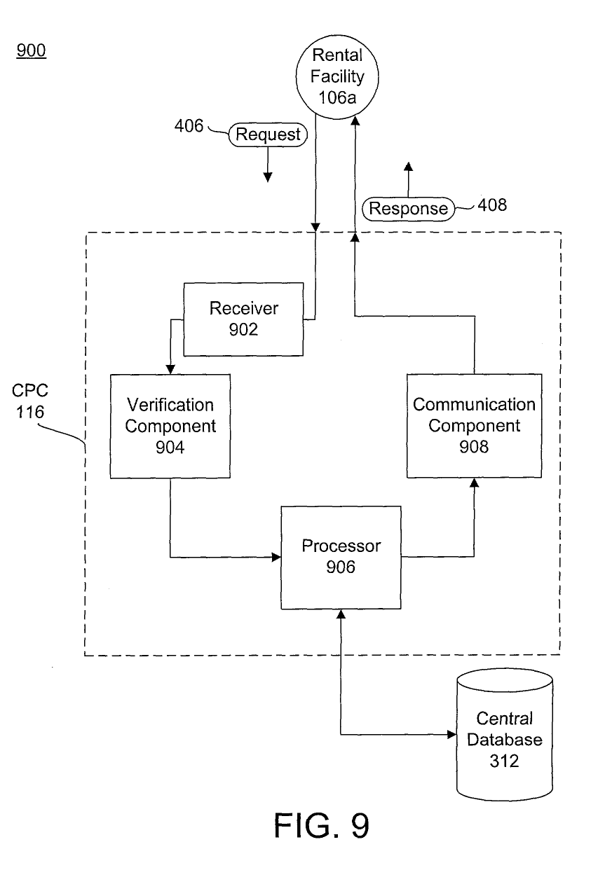

Referring now to FIG. 9, a system 900 for managing a plurality of rental facilities 106 is illustrated. The depicted logical components may be implemented using one or more of the physical components shown in FIGS. 2 and 3. Of course, other well known physical components typically used in a CPC 116 may be used to implement the depicted logical components. Additionally, or in the alternative, various logical components may be implemented as software modules stored in memory and/or a storage device and executed by a CPU. Those skilled in the art will recognize that various illustrated components may be combined together or integrated with standard components in various configurations without departing from the scope or spirit of the invention.

As noted above, a web browser at a rental facility 106, or elsewhere, may send a rental facility transaction request 406 which is received at the CPC 116. The system 900 may include a receiver 902, which receives the request 406, as described above in connection with FIG. 4. The receiver 902 may be implemented as a software module executing on a CPU in communication with a network interface (not shown) of the CPC 116. The network interface monitors incoming packets received from the WAN 102 and/or the Internet 104. Of course, a variety of other implementations are possible.

The system 900 may also include a verification component 904 in communication with the receiver 902. In one implementation, once the receiver 902 detects a request 406, the verification component 904 reads an authorization indicator from the request 406 The authorization indicator is compared with an authorization level required for the requested rental facility transaction 404. The requested rental facility transaction 404 is then denied or allowed, as described in connection with FIG. 4.

The processor 906 may identify the requested rental facility transaction 404 from the request 406. If the requested rental facility transaction 404 is allowed, a processor 906 conducts the transaction 404 using rental information stored within the central database 312. The processor 906 may comprise a CPU executing a central software module, specialized hardware, or other like module well known to those of skill in the art.

The processor 906 communicates with the communication component 908 to compile and format a result. The result of the rental facility transaction 404 is transmitted by the communication component 908, in the form of a response 408, back to the web browser. As mentioned above, the response 408 may be a web page, an acknowledgement, or the like.

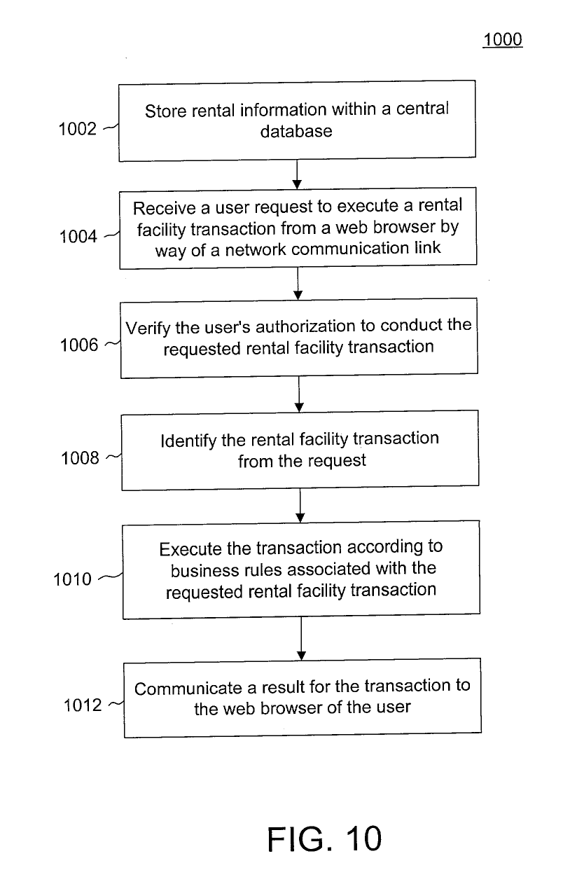

Referring now to FIG. 10, there is shown a flowchart of a method 1000 for managing a plurality of rental facilities 106. The method 1000 begins by storing 1002 rental information within a central database 312. Next, a request 406 from a web browser is received 1004 via a network communication link 108 to execute a rental facility transaction 404. Thereafter, the user's authorization to conduct the requested rental facility transaction 404 is verified 1006.

Next, the rental facility transaction 404 is identified 1008 from the request 406. Thereafter, the rental facility transaction 404 is executed 1010 according to business rules associated with the requested rental facility transaction 404. Finally, a result for the transaction 404 is communicated 1012 to the web browser of the user.

Based on the foregoing, the present invention offers a number of advantages not available in conventional approaches. Changes to rental information are available for subsequent transactions in real-time. Business rules and policies may be enforced at a plurality of rental facilities 106. Facility-specific information is readily available for reports, and analysis. In addition, backing up data and maintaining a software program implementing the present invention is facilitated because the software and rental information are centrally located.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

What is claimed is:

1. A method for managing a plurality of rental facilities using a central processing center, the method comprising:
storing rental information within a central database;
receiving from a user a request to execute a rental facility transaction, the request originating from a web browser by way of a network communication link;
conducting the requested transaction using rental information stored within the central database accessible by the central processing center; and
communicating a result for the transaction to the web browser.

2. The method of claim 1, wherein the rental facility transaction comprises modifying the rental information, the modification being available in real-time for subsequent rental facility transactions.

3. The method of claim 2, wherein rental information includes business rules and wherein rental facility transaction comprises a management transaction.

4. The method of claim 2, wherein rental facility transaction comprises an operational transaction.

5. The method of claim 3, wherein the business rules comprise common business rules which apply to substantially all rental facilities.

6. The method of claim 3, wherein the business rules comprise facility-specific business rules which apply to at least one rental facility.

7. The method of claim 3, wherein the request is received by a web software component at the central processing center and wherein the management transaction comprises modifying code for the web software component in real-time.

8. The method of claim 3, wherein rental information includes facility-specific information and wherein the management transaction comprises modifying facility-specific information.

9. The method of claim 8, wherein the management transaction comprises generating a report containing at least a portion of facility-specific information for at least one facility.

10. The method of claim 4, wherein rental information includes facility-specific information and wherein the operational transaction comprises modifying the facility-specific information to reserve a rental unit for the user.

11. The method of claim 4, wherein the operational transaction comprises processing a rent payment by communicating with a financial processing center by way of the network communication link.

12. The method of claim 4, wherein the operational transaction comprises processing a sale of merchandise.

13. The method of claim 4, wherein the operational transaction comprises managing an existing rental account.

14. The method of claim 4, wherein the operational transaction comprises managing a delinquent rental account.

15. The method of claim 3, wherein conducting the requested transaction further comprises:
identifying the requested rental facility transaction from the request; and
executing the requested rental facility transaction according to the business rules associated with the requested rental facility transaction.

16. The method of claim 1, further comprising:
reading an authorization indicator from the request;
comparing the authorization indicator to an authorization level required for the rental facility transaction included in the request; and
denying the user's request to conduct the requested rental facility transaction, in response to the authorization indicator not satisfying the authorization level required for the rental facility transaction.

17. The method of claim 1, wherein the central database retains historical information for at least one closed rental account and wherein the rental facility transaction comprises generating a report comprising the historical information.

18. The method of claim 1, wherein the user is physically remote to at least one rental facility,. the at least one rental facility being a subject of the requested rental facility transaction.

19. The method of claim 1, wherein the web browser comprises a cache that stores persistent rental information.

20. The method of claim 1, wherein the rental facility comprises a self-storage rental facility.

21. A system for managing a plurality of rental facilities using a central processing center, the system comprising:
a central database that stores rental information;
a receiver that receives user requests to execute rental facility transactions, user requests originating from web browsers by way of a network communication link;
a processor that conducts the requested transaction using rental information stored within the central database accessible by the central processing center; and
a communication component that communicates a result for the transaction to the web browser.

22. The system of claim 21, wherein the rental facility transaction comprises modifying the rental information, the modification being available in real-time for subsequent rental facility transactions.

23. The system of claim 22, wherein rental information includes business rules and wherein rental facility transaction comprises a management transaction.

24. The system of claim 22, wherein rental facility transaction comprises an operational transaction.

25. The system of claim 23, wherein the business rules comprise common business rules which apply to substantially all rental facilities.

26. The system of claim 23, wherein the business rules comprise facility-specific business rules which apply to at least one rental facility.

27. The system of claim 23, wherein the request is received by a web software component at the central processing center and wherein the management transaction comprises modifying code for the web software component in real-time.

28. The system of claim 23, wherein rental information includes facility-specific information and wherein the management transaction comprises modifying facility-specific information.

29. The system of claim 28, wherein the management transaction comprises generating a report containing at least a portion of facility-specific information for at least one facility.

30. The system of claim 24 wherein rental information includes facility-specific information and wherein the operational transaction comprises modifying the facility-specific information to reserve a rental unit for the user.

31. The system of claim 24, wherein the operational transaction comprises processing a rent payment by communicating with a financial processing center by way of the network communication link.

32. The system of claim 24, wherein the operational transaction comprises processing a sale of merchandise.

33. The system of claim 24, wherein the operational transaction comprises managing an existing rental account.

34. The system of claim 21, wherein the processor identifies the requested rental facility transaction from the request and executes the requested rental facility transaction according to the business rules associated with the requested rental facility transaction.

35. The system of claim 21, further comprising a verification component that reads an authorization indicator from the request, compares the authorization indicator to an authorization level required for the rental facility transaction included in the request and denies the user's request to conduct the requested rental facility transaction, in response to the authorization indicator not satisfying the authorization level required for the rental facility transaction.

36. The system of claim 21, wherein the central database retains historical information for at least one closed rental account and wherein the rental facility transaction comprises generating a report comprising the historical information.

37. The system of claim 21, wherein the user is physically remote to at least one rental facility, the at least one rental facility being a subject of the requested rental facility transaction.

38. The system of claim 21, wherein the web browser comprises a cache that stores persistent rental information.

39. The system of claim 21, wherein the rental facility comprises a self-storage rental facility.

40. A method for managing a plurality of rental facilities according to business rules, the method comprising:
providing a central software module programmed to enforce the business rules, the central software module being in communication with a central database;
permitting users to conduct rental facility transactions with the central software module for at least one rental facility through an Internet browser; and
compiling the results of the rental facility transactions in the central database.

41. The method of claim 40, further comprising:
restricting access to specific rental facility transactions because of access restrictions associated with each user.

42. The method of claim 40, further comprising:
authorizing a user to override at least one business rule.

43. The method of claim 42, further comprising:
in response to a user overriding at least one business rule, creating a notification that an override has occurred.

44. The method of claim 40, wherein the central software module is web-enabled.

45. The method of claim 40, wherein the business rules comprise common business rules which apply to substantially all rental facilities.

46. The method of claim 40, wherein the business rules comprise facility-specific business rules which apply to at least one rental facility.

47. The method of claim 40, wherein the business rules are modifiable in real-time.

48. A system for managing a plurality of rental facilities using a central processing center, the system comprising:
means for storing rental information within a central database;
means for receiving from a user a request to execute a rental facility transaction, the request originating from a web browser by way of a network communication link;
means for conducting the requested transaction using rental information stored within the central database accessible by the central processing center; and
means for communicating a result for the transaction to the web browser.
